(19) United States
(12) Patent Application Publication
(10) Pub. No.: US 2026/0109493 A1
(43) Pub. Date: Apr. 23, 2026

(54) UNMANNED AERIAL VEHICLES FOR LIQUID APPLICATION

(71) Applicant: Emmanuel McMillan, Mackinaw City, MI (US)

(72) Inventor: Emmanuel McMillan, Mackinaw City, MI (US)

(21) Appl. No.: 19/482,313

(22) PCT Filed: May 8, 2024
(86) PCT No.: PCT/US2024/028393

§ 371 Date: Nov. 7, 2025

Related U.S. Application Data
(60) Provisional application No. 63/500,968, filed on May 9, 2023.

(51) Int. Cl. B64U 20/70; B05B 13/00; B64U 10/16; B64U 20/50; B64U 20/83; B64U 30/293; B64U 50/19; B64U 50/30; B64U 101/28

(52) U.S. Cl. CPC B64U 20/70; B05B 13/005; B64U 10/16; B64U 20/50; B64U 20/83; B64U 30/293; B64U 50/19; B64U 50/30; B64U 2101/28; B64U 2201/20

(57) ABSTRACT

Described herein are unmanned aerial vehicles (UAV) for applying liquids to a surface, for example high altitude or difficult to reach surfaces. The UAV can include one or more propellers rotatably coupled to a body; a processor; a power source coupled to the processor and the one or more propellers; a reservoir removably coupled to the body; and an applicator coupled to the paint reservoir or the body. The applicator is fluidly coupled to the reservoir and electrically coupled to the processor.

### CROSS-REFERENCE TO RELATED APPLICATIONS

This application claims the priority benefit of U.S. Provisional Patent Application Ser. No. 63/500,968, filed May 9, 2023, the contents of which are herein incorporated by reference in their entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of unmanned aerial vehicles, and more specifically to the field of infrastructure maintenance and repair. Described herein are unmanned aerial vehicles for liquid application, for example paint.

### BACKGROUND

There are several technologies available to choose from when painting. The type of technology selected depends on various factors like the structure's type, size, and desired finish. Some of the commonly used painting technologies include, but are not limited to: brushes, rollers, airless sprayers, airbrushes, electrostatic sprayers, powder coating, and high-volume, low-pressure spray guns. To prepare the surface before painting, equipment like pressure washers, sandblasters, and chemical cleaners can be used. Accessing difficult-to-reach areas of the structure can be achieved through scaffolding, rope access, elevated work platforms, ladders, and the like.

Brushes: Brushes of various sizes, including large brushes and small brushes, are used for painting on a large scale. Bristle brushes, foam brushes, and flat brushes are the commonly used types.

Roller painting: This technique involves using a roller to apply paint on a surface, and it is commonly used for painting large areas like walls, ceilings, and floors.

Airless Sprayers: Airbrushes use compressed air to spray paint onto a surface and are commonly used for large-scale painting projects.

Electrostatic Sprayers: This technique involves charging paint particles with an electric charge, so that the charged paint particles are then attracted to a grounded surface. It is commonly used for painting large metal surfaces such as fences, towers, tanks, and industrial equipment.

Powder coating: Powder coating is a method of painting that involves applying a dry powder to a surface and then curing it with heat. This method is often used for painting large metal structures, such as bridges and towers.

High-Volume, Low-Pressure (HVLP) Spray Guns: HVLP spray guns use a high volume of air to atomize the paint, resulting in less overspray and waste. This technology can be useful for painting large surfaces that have a fine finish, such as cars and aircraft.

Surface Preparation Equipment: Before painting, the surface of the structure can be cleaned and prepared. Equipment such as pressure washers, sandblasters, and chemical cleaners can be used to prepare the surface for painting.

Scaffolding: Scaffolding is a temporary platform or structure that is built around the structure to provide a stable and safe working platform for painters. The scaffolding can be made of wood, steel, or aluminum and can be used to access hard-to-reach areas of the structure.

Rope Access: Rope access is a method of accessing difficult-to-reach areas of a structure by using ropes, harnesses, and other safety equipment. Rope access is commonly used for painting high-rise buildings, bridges, and towers. The painters are trained to use ropes and safety equipment to reach areas that cannot be accessed by scaffolding or other equipment.

Elevated Work Platforms (EWP): EWP are machines that provide a stable and safe platform for painters to work at height. EWPs can be truck-mounted, self-propelled, or trailer-mounted and can reach heights of up to about 100 meters. EWPs are commonly used for painting buildings, bridges, and towers.

Sandblast: Sandblasters are used to prepare the surface before painting.

Ladders: Ladders are used for painting smaller structures or for accessing hard-to-reach areas of a structure. Extension ladders can be used to reach higher areas, and painters are trained to use ladders safely.

### SUMMARY

In some aspects, the techniques described herein relate to an unmanned aerial vehicle including: an annular body including a plurality of motors; a plurality of propellers coupled to the annular body and electrically coupled to the plurality of motors; and a fuselage removably insertable into the annular body and electrically connectable to the annular body, wherein the fuselage includes: a processor coupled to a memory, a reservoir configured to contain a liquid therein, a pump fluidly connected to the reservoir, a nozzle fluidly connected to the reservoir and the pump, and a power source electrically coupled to the plurality of motors and the plurality of propellers when the fuselage is coupled to the annular body, the processor, the memory, and the pump.

In some aspects, the techniques described herein relate to a method for maintaining power to an unmanned aerial vehicle during replacement or transfer of a reservoir, including: a mini battery system attached to a body of the unmanned aerial vehicle, separate from a main power source; a power supplier configured to switch from the main power source to the mini battery system upon disconnection of the main power source; and a timer configured to maintain the power to the unmanned aerial vehicle for a predetermined period after the main power source is disconnected.

In some aspects, the techniques described herein relate to a battery system for an unmanned aerial vehicle (UAV) and a reservoir system, including: a battery housing configured to receive and hold a power source; and a power output module integrated with the battery housing, the power output module including: a plurality of output connectors, each connector configured to transfer an amount of electrical power; a power management unit configured to manage a distribution of the electrical power from the power source to the plurality of output connectors; and a control circuit is configured to regulate a flow of power to the plurality of output connectors based on one or more power requirements of the UAV and the reservoir system.

In some aspects, the techniques described herein relate to a system for spraying a liquid including: a spraying unmanned aerial vehicle including a reservoir and an extension rod, the extension rod having a nozzle configured to spray the liquid from the reservoir; two or more servos attached to the extension rod, the two or more servos being configured to move the extension rod; and a control system configured to control the two or more servos and a movement of the reservoir, wherein the spraying unmanned aerial vehicle is positioned at a predetermined point, and the two or more servos are activated to rotate the extension rod, causing the nozzle to spray a predetermined line or an assigned box.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a perspective view of an embodiment of an unmanned aerial vehicle (UAV) for liquid application.

FIG. 2 illustrates a box diagram of an embodiment of a UAV for liquid application.

FIG. 3 illustrates a box diagram of an embodiment of an annular body and a fuselage of a UAV for liquid application.

FIG. 4 illustrates a box diagram of an embodiment of a fuselage of a UAV for liquid application.

FIG. 5 shows a side view of an embodiment of a fuselage of a UAV for liquid application.

FIG. 6 shows a side view of an embodiment of a fuselage of a UAV for liquid application.

FIG. 7 shows a partially exploded view of an embodiment of a fuselage of a UAV for liquid application.

FIG. 8 shows a top view of an embodiment of an annular body of a UAV for liquid application.

FIG. 9 shows a top view of an embodiment of an annular body of a UAV for liquid application.

FIG. 10 shows a top view of an embodiment of an annular body of a UAV for liquid application in an inactive or folded configuration.

FIG. 11 is a flow chart of an embodiment of a method of operating a UAV.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as Described and illustrated herein, can be arranged, combined, modified, and designed in a variety of different formulations, all of which are explicitly contemplated and form part of this disclosure.

The above various methods and techniques, such as the use of: bristle brushes; foam brushes; flat brushes; roller painting; airless sprayers; airbrushes; electrostatic sprayers; powder coating; high-volume, low-pressure (HVLP) spray guns ; surface preparation equipment; rope access; elevated work platforms; and ladders, are inadequate due to various limitations. For example, bristle brushes are often used for small-scale painting projects but are inadequate for large structures (e.g., statues, infrastructure, etc.), because bristle brushes are time-consuming and do not provide an even coverage of paint. Foam brushes may be useful for applying paint to certain areas of a structure, but foam brushes are not efficient for covering large areas as they tend to leave behind visible brush strokes. Flat brushes may be useful for some applications, but flat brushes are not ideal for painting large structures, because flat brushes cannot hold as much paint as other painting tools, leading to frequent refilling and uneven paint coverage. While rollers can cover large areas quickly, rollers are not the best choice for painting structures, because rollers tend to leave behind a textured surface and are not capable of reaching certain areas. Airless sprayers can be useful for painting large surfaces, but airless sprayers can also result in overspray and uneven paint coverage. Airbrushes are useful for intricate painting work, but airbrushes are not well-suited for painting large structures, because airbrushes are time-consuming and may result in uneven coverage. Electrostatic sprayers are designed to provide an even, controlled paint application, but electrostatic sprayers are not the best choice for painting large structures, because electrostatic sprayers require a large amount of power and are not easily maneuverable. Powder coating is a useful technique for creating a durable finish, but powder coating is not well-suited for painting large structures, because powder coating uses specialized equipment and a controlled environment. HVLP spray guns can be useful for painting large surfaces, but HVLP spray guns are not ideal for painting structures, because HVLP spray guns are not as efficient as other painting tools and may result in overspray and uneven coverage. While surface preparation equipment is often used for preparing surfaces for painting, surface preparation equipment is not a painting tool in and of itself. Rope access techniques are often used for accessing hard-to-reach areas, but rope access techniques are not the best choice for painting large structures, because rope access techniques are time-consuming and may pose safety risks. Elevated work platforms can provide access to high structures, but elevated work platforms can be unsafe or unstable and may not be able to reach certain areas of a structure. Ladders may be useful for painting small areas, but ladders are not the best choice for painting large structures, because ladders are not as stable as other access methods and may pose safety risks. Accordingly, new systems, devices, and methods are needed for applying liquid to a surface, for example high altitude surfaces or surfaces that are difficult for a person to reach with the above listed techniques and methods.

The UAVs and related methods described herein solve the above technical problems with technical solutions. The UAVs described herein provide an advanced and efficient system designed specifically for applying liquid to a surface, such as buildings, bridges, and other infrastructure. The UAVs can be equipped with a hexacopter drone that serves as the platform for carrying the reservoir and the applicator. When compared to, for example, a quadracopter, a hexacopter may be advantageous in stability and increased payload. The UAV may be optionally equipped with one or more sensors (e.g., accelerometer, gyroscope, proximity sensor, liquid detection, battery detection, vibration protection, etc.), a global positioning (GPS) receiver or other location system, one or more inertial sensors, and one or more cameras that allow the UAV to navigate and avoid obstacles while painting. The UAV can be programmed to follow predetermined patterns or lines to ensure accuracy and consistency in the painting process.

The UAVs described herein may have a load capacity of about 5 kg to about 20 kg. In some embodiments, a UAV as described herein may have a take-off weight of about 10 kg to about 36 kg. The hovering endurance of the UAV without a load may be about 20 minutes to about 25 minutes. The hovering endurance of the UAV with a load may be about 7 minutes to about 10 minutes. The hovering precision of the UAV may be about ±50 cm (horizontal) and about ±20 cm (vertical). The operation flight speed of the UAV may be about 0.5 meters per second to about 1 meter per second; about 1 meter per second to about 10 meters per second.

The operable wind speed of the UAV may be about 3 meters per second to about 8 meters per second. A flight radius of the UAV may be up to about 1,000 meters. The UAV may be capable of reaching a flight altitude of about 2,000 meters. The operating ambient humidity for the UAV may be less than about 93%.

Although a hexacopter UAV is described herein, other UAVs or UAV configurations could also be used.

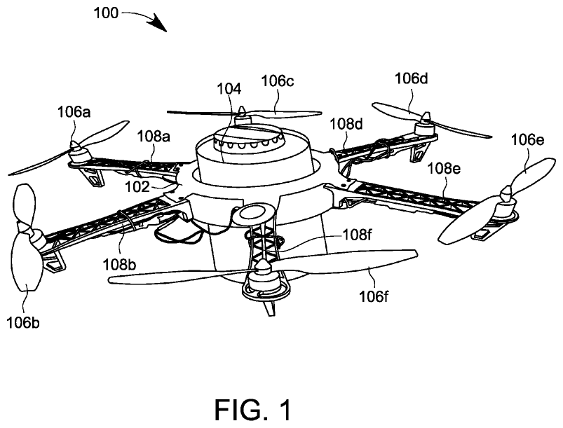

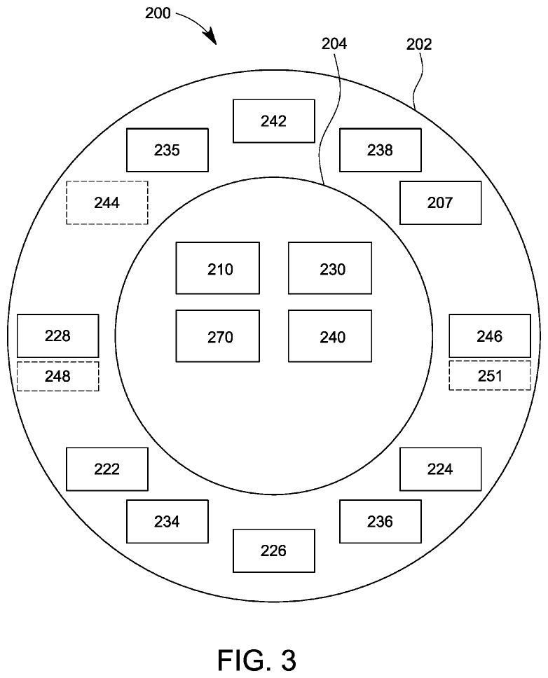

FIG. 1 shows an embodiment of a UAV 100 for liquid application. UAV 100 includes a plurality of arms 108 (e.g., arm 108a, 108b, 108c, 108d, etc.) coupled to propellers 106 (e.g., propeller 106a, 106b, 106c, 106d, etc.). Each arm 108 may terminate in a propeller 106 or each propeller 106 may be anywhere along the length of each arm 108. The plurality of arms 108 extend from body 102. Fuselage 104 is reversibly insertable into and couplable to body 102. Body 102 may have an annular shape, toroidal shape, or other three-dimensional shape (e.g., square, rectangle, hexagon, octagon, etc.) defining an aperture 203 (shown in FIG. 3) therethrough.

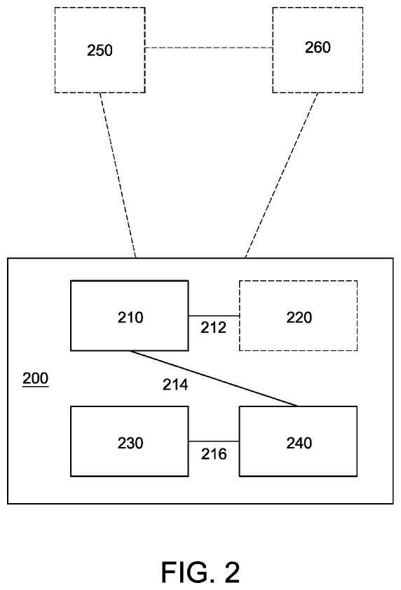

FIG. 2 illustrates a box diagram of an embodiment of a UAV for liquid application. UAV 200 includes a processor 210 electrically coupled 214 to an applicator 240. Reservoir 230 is fluidly coupled through one or more conduits 216 to applicator 240 (e.g., sprayer, brush, nozzles, etc.). Processor 210 may also be electrically coupled 212 to one or more optional sensor(s) 220. Optional computing device 250 (e.g., input device or user input device) is communicatively coupled to UAV 200. Further, optional server 260 can be communicatively coupled to optional computing device 250 and/or UAV 200. In some embodiments, conduit 216 includes a fluid conduit and an electrical conduit. The fluid conduit may enable fluid from the reservoir 230 to flow from the reservoir to the pump. The electrical conduit may establish dual electrical connections between the pump 280 and the processor 210; and between the pump 280 and the power source 270. The dual electrical connections enable the UAV 200 to regulate the operation of the pump 280 and control the spray pattern of the nozzle. This configuration solves the technical problem of control for achieving the desired spraying parameters, such as flow rate, droplet size, and spray angle.

In some embodiments, the UAV 200 can be communicatively couplable to a remote input device (e.g., computing device 250) equipped with a range of features that allow the user to adjust a speed of the UAV, a direction of the UAV, an amount of liquid applied, etc. In addition to being able to program the UAV 200 to follow predetermined patterns or lines, the computing device 250 may also allow the user to manually control the UAV 200. These control features give the user more flexibility and control over the liquid application process, allowing the user to make adjustments on a case-by-case basis. The computing device 250 can be equipped with a range of features that allow the user to adjust the speed and direction of the UAV 200, as well as the amount of liquid being applied. The computing device 250 further enhances the accuracy and precision of the system, allowing the user to achieve the desired results with ease.

The computing device 250 may optionally cause the UAV 200 to: execute an automatic flight operation, execute take-off or landing (e.g., based on an input), cause the applicator to continue spraying at a breakpoint, execute an auto return when finishing a spray application or low liquid levels, execute an auto return when low battery, cause an amount of liquid to be detected, set a breakpoint record, cause a battery level to be detected, execute a return on low battery based on an input, execute a set record point, activate a height control radar, and/or set a stable altitude.

In some embodiments, the UAV 200 or computing device 250 communicatively coupled to the UAV 200 may include a set of power source features that enable power source detection and/or low battery return. The UAV 200 or a computing device 250 may optionally include a record point setting which detects the battery level and uses the computing device 250 to set a return point when the battery level gets low. Liquid detection and break point record setting detects the amount of liquid in the tank and can set a breakpoint for the drone to stop and return to a starting point to refill.

The optional one or more sensors 220 may provide real-time feedback to the processor 210. This feedback can be used to adjust the movement, position, location, etc. of the UAV 200. The one or more optional sensors 220 can include one or more rangefinder sensors, GPS receiver, magnetometer, gyroscope, accelerometer, radar, image sensor, one or more environmental sensors (e.g., humidity sensor, temperature sensor, atmospheric pressure sensor, noise sensor, sunlight sensor, wind speed sensor, image sensor or camera, etc.), etc. The one or more sensors 220 may include sensors for the detection and/or measurement of liquid amounts in reservoir 230. For example, one or more rangefinders (e.g., ultrasonic rangefinders) may be oriented to measure the height of the fluid column in the reservoir. Alternatively, or additionally, the weight of the fluid within the reservoir 230 may be measured as an indication of the amount.

For example, to accurately maintain a position and/or orientation of the UAV 200 relative to the surface to be painted, the UAV 200 can include and use sensors 220, for example, a rangefinder sensor to measure distance to a target by emitting a signal (e.g., sound waves or light waves), and receiving the reflected signal. A rangefinder sensor can be used to determine the distance between the UAV 200 and the surface to be painted, which can help the UAV 200 maintain a safe and consistent distance from the surface.

An accelerometer may be used to detect changes in a velocity and/or direction of movement of the UAV 200, which can help the UAV 200 maintain a stable flight path while applying a liquid to a surface.

A magnetometer may be used to measure a strength and/or direction of a magnetic field. A magnetometer can be used to determine an orientation of the UAV 200 relative to the Earth's magnetic field, which can help the UAV 200 maintain a consistent heading while applying a liquid.

A gyroscope may be used to detect changes in an orientation and/or angular velocity (UAV position in three-dimensional space) of the UAV 200, which can help the UAV maintain a stable flight path and consistent liquid application technique.

A radar may be used for height control and/or altitude sensing to maintain a stable altitude and adjust the height of the UAV 200 automatically. Additionally, or alternatively, a GPS receiver may be used to ensure that the UAV 200 maintains an accurate and precise position, enabling the UAV to fly more efficiently.

The UAV 200 may include one or more environmental sensors to measure environmental factors, for example, wind, speed, humidity, etc. The UAV 200 can adapt liquid application, flying, etc. according to one or more detected environmental conditions, for example weather calibration. The UAV 200 may automatically adjust liquid application parameters based on weather conditions. Weather calibration may ensure optimal performance even in challenging environments, such as windy or rainy conditions. For example, the processor 210 can analyze the environmental factor data and adjust painting parameters (e.g., spray angle, paint flow rate) for improved performance in challenging weather conditions.

In some embodiments, the UAVs described herein include an imaging and/or mapping system for performing mapping of one or more surfaces (e.g., a building, structure, statue, wall, etc.), for example, for the purpose of applying a liquid. For example, a UAV 200 may include an optional image sensor mounted on the UAV 200. The optional image sensor can capture images of the one or more surfaces. A processor (e.g., local processor 210 on the UAV 200 or a remote processor in an input device or a remote computing device 250) can receive the images from the optional image sensor and generate a three-dimensional (3D) model of the surface. The processor may further execute instructions including converting the 3D model into a grid and linear map of the one or more surfaces for applying a liquid. In some embodiments, a method may include receiving location data of the one or more surfaces to be painted (or liquid applied to) using a GPS receiver and/or receiving 3D location data from one or more Real-Time Kinematic (RTK) devices (e.g., additional UAVs or other devices) around the one or more surfaces; using the location data obtained from GPS receiver and/or RTK devices to generate a virtual 3D model of the one or more surfaces; overlaying a linear and/or grid line onto the virtual 3D model to create a reference map for the UAV; and causing the UAV 200 to apply the liquid to the one or more surfaces based on the reference vertical map view using the linear and/or grid line. In some embodiments, a system for implementing the method includes a UAV 200 equipped with a GPS receiver for obtaining location data of the one or more surfaces to have liquid applied; multiple RTK devices (or the GPS sensor is RTK enabled) deployed around the one or more surfaces to obtain 3D location data; and a processor for generating a virtual 3D model of the one or more surfaces using the location data obtained from GPS receiver and/or RTK devices (or GPS receiver that is RTK enabled). In some embodiments, the processor may further execute or be electrically coupled to a vertical mapping module for overlaying a linear and grid system onto the virtual 3D model to create a reference map for the UAV. The processor may further execute or be electrically coupled to a control module for guiding the UAV 200 to spray liquid on the one or more surfaces based on the reference map using the linear and grid line system. By using a horizontal mapping approach, the system provides a solution for vertical mapping that is suitable for painting infrastructure.

For real-time monitoring and feedback, in some embodiments, the UAV 200 can be equipped with one or more optional image sensors and optional image processing software. The processor 210 receives and analyzes the image sensor data from the optional image sensor to determine and output information on quality factors, for example, paint application and coverage. Measuring quality factors allows for prompt adjustments to improve painting results. In some embodiments, the UAV 200 has a detachable camera mount, allowing the user to attach a camera to the UAV 200 to capture images and/or video of the painting process. Alternatively, the camera may be embedded in the UAV 200, attachable to the body or fuselage of the UAV 200, or otherwise integrated into the UAV 200.

In some embodiments, one or more UAVs 200 described herein may optionally include one or more lasers. The one or more optional lasers, and one or more feedback loops, may be used for real-time quality assurance. The processor 210 can receive and analyze the laser data to identify inconsistencies in paint application. Identifying inconsistencies in paint application allows for real-time adjustments to guarantee high-quality painting results.

In some embodiments, the processor 210 of the UAV 200 or a communicatively coupled computing device 250 can execute one or more machine learning algorithms, in combination with in-coming sensor data, for autonomous surface recognition. The processor may receive sensor data, analyze the sensor data, and identify and adapt painting techniques based on a characteristic of a surface.

In some embodiments, the UAV 200 may employ a continuous spraying at breakpoint method to enable the UAV to continue spraying from the point or line where the spraying stopped, ensuring that areas are not missed or double-sprayed.

The processor 210 of the UAV 200 may execute a variable-flow paint delivery method. The processor 210 may adjust a flowrate of liquid (e.g., paint) and/or speed of application based on user input, project requirements, desired paint thickness, desired thickness of liquid application, etc., enabling dynamic liquid application control.

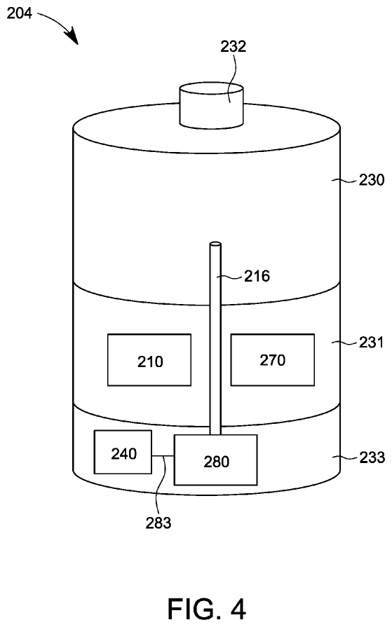

FIG. 3 illustrates a box diagram of an embodiment of an annular body 202 and a fuselage 204 of a UAV 200 for liquid application. The fuselage 204 may include the processor 210, reservoir 230, applicator 240, and power source 270. The fuselage 204 components will be described in greater detail in connection with FIGS. 4, 7-8. The annular body 202 may include a plurality of motors (e.g., motor 235, motor 234, motor 236, motor 238, optional motor 248, optional motor 251), a receiver 222, a flight controller 224, an electronic speed controller (ESC) 226, a mini battery system 228, a GPS receiver 242 (optionally capable of real time kinematics), optional camera 244 (as described elsewhere herein), an altitude radar 246, and a power module 207.

The receiver 222 of UAV 200 may receive inputs from an input device (e.g., computing device 250) to alter a function (e.g., liquid application, sensor function, etc.) of the UAV 200 or a flying pattern of the UAV 200.

The flight controller 224 (with optionally integrated or separate GPS receiver 242, receiver 222, ESC 226, etc.) is electrically connected to one or more optional sensors (e.g., inertial measurement unit (IMU), gyroscope, etc.) to affect a flight path of the UAV 200, either autonomously and/or based on input from an input device (e.g., computing device 250). In some embodiments, the flight controller 224 of a first UAV 200 may communicate with additional UAVs for swarm intelligence painting. For example, two or more or a plurality of UAVs can communicate with each other to collaborate seamlessly. Swarm intelligence painting enables the UAVs to efficiently paint large-scale structures through intelligent task distribution and reduced project timelines. Further for example, the flight controller 224 may cause the UAV 200 to hover to allow for precise spraying of liquids onto a targeted area. For example, by using the reservoir and the extension rod with the nozzle, the UAV 200 can cover a designated line. The two or more servos attached to the extension rod can cause movement (e.g., swing) of the extension rod, which enables the UAV 200 to cover a wider area while hovering.

The ESC 226 (e.g., each motor may be paired with an ESC) controls and regulates the speed of each motor (e.g., motor 235, motor 234, motor 236, motor 238, optional motor 248, optional motor 251). The motors may be brushed or brushless. The ESCs 226 control the speed of the motors by regulating the electrical current that flows to the motor. The motors are coupled to the flight controller 224, which, as described above, is the main component that governs the flight of the UAV 200. The flight controller 224 receives signals from the input device and processes the signals to adjust the speed of the motors and control the movement of the UAV 200. ESC 226 may also function to reverse one or more motors and/or cause braking and/or deceleration of the one or more motors.

The mini battery system 228 functions to provide limited power to the body 202 of the UAV 200, for example when the reservoir 230 is removed to add more liquid. The mini battery system 228 is separate from power source 270. The mini battery system 228 includes a power supplier configured to switch from the power source 270 to the mini battery system 228 upon disconnection of the power source 270 (e.g., removal of the fuselage 204 from the body 202), and a timer configured to maintain power to the body 202 for a predetermined period after the power source 270 is disconnected. For example, the predetermined period, for example can be up to about 20 seconds to about 10 minutes (although the type of flight controller and/or the volume of data being retained can also influence the duration). The power supplier may be a switch or a relay. The mini battery system 228 may be a rechargeable battery. The timer may be programmable, for example a microcontroller. The mini battery system 228 may further include a sensor for detecting disconnection of the power source 270 from the mini battery system 228. The sensor may be a switch, for example, or a Hall effect sensor. When the power source is disconnected, the magnetic field around the power source 270 changes, and the Hall effect sensor can detect this change and trigger the mini battery system 228 in the body 202 of the UAV 200 to be activated. For example, the Hall effect sensor may be positioned such that it is close to the power source 270 and can detect changes in the magnetic field. The power source 270 can also be connected to the processor 210 to trigger the mini battery system 228 automatically. Using a Hall effect sensor in combination with the mini battery system 228 ensures that the UAV 200 remains powered on during the period of replacing or transferring a reservoir 230, without a complete power-off and restart of the UAV 200. The mini battery system 228 enables the UAV 200 to maintain its state when swapping out the reservoir 230 or otherwise making adjustments to the fuselage 204 in between liquid application cycles. Further, the mini battery system 228 can serve as a stable power source for the body 202 to protect sensitive electronic components from damage and ensure uninterrupted functionality. In the event of low battery or system failure, the mini battery system 228 can power autonomous return to base protocols, guiding the UAV 200 back to a designated landing zone safely. In some embodiments, UAV 200 may include a crank system to extract energy from the rotations from the propellers. The crank system may allow the mini battery system 228 to charge using the kinetic energy generated by the propellers.

The mini battery system 228 solves a technical problem of power distribution between the various components of the UAV 200. The technical solution provided herein includes an electrical compartment 231 (e.g., shown in FIG. 4 in the fuselage 204) to manage the distribution of electrical power from the power source 270 in the fuselage 204 (including reservoir) to the body 202 (which includes the mini battery system 228) of the UAV 200, while regulating the power flow based on the power requirements of each component.

The power source 270 may be a removable battery or an integrated or rechargeable battery with a weight of about 4.0 kg to about 7 kg. The rated power may be between about 1,080 W and about 2,400 W. For example, the power source 270 may be able to support a plurality of motors with a stator size of about 7020 mm to about 9620 mm, and a plurality of propellers 206. The electrical compartment 231 is a protective enclosure that houses the power source 270, ensuring the safety and security of the power source 270 during the spraying process.

The electrical compartment 231 houses the power source 270, a power output module 207, and a connector module. The power output module 207 has a power management unit and a control circuit to manage the distribution of electrical power from the power source 270 to a plurality of output connectors. The connector module has, for example, three connectors, which are configured to provide electrical power to the body 202 of the UAV 200 and the reservoir 230 and receive electrical power from the power source 270. The electrical compartment 231 has a voltage regulator to maintain a constant voltage output to the output connectors. The connector module has a plurality of pins, which connect the components in the electrical compartment 231 to corresponding ports on the body 202 of the UAV 200 and the reservoir 230. Although three connectors are described, one of skill in the art will appreciate that any number of connectors may be used to receive or output power to any number of compartments or components. The electrical compartment 231 may also include a safety circuit configured to detect and prevent overloading or short-circuiting of electrical circuits, and to shut down the power source 270 if an overload or short-circuit is detected.

The GPS receiver 242 (optionally capable of RTK) and an altitude radar 246 may work in tandem to achieve accurate UAV 200 positioning during spraying. For example, the RTK can correct for GPS receiver 242 errors, while the altitude radar 246 furnishes real-time distance data from the ground. This enables controlled and uniform spraying, ensuring improved coverage and minimizing waste.

FIG. 4 illustrates a box diagram of an embodiment of a fuselage 204 of a UAV 200 for liquid application. The fuselage 204 includes a processor 210 for executing one or more methods as described elsewhere herein. The fuselage 204 further includes a power source 270 and electrical compartment 231, as described above. The fuselage 204 includes a reservoir 230 with reservoir inlet 232 for receiving a liquid therethrough. Alternatively, the reservoir 230 can include a removable lid or cap for refilling the liquid in the reservoir 230. Conduit 216 fluidly connects the reservoir 230 to the liquid application compartment 233. The liquid application compartment 233 includes pump 280 and applicator 240. Conduit 216 fluidly connects the reservoir 230 to the pump 280. The pump 280 is fluidly coupled to applicator 240 through conduit 283.

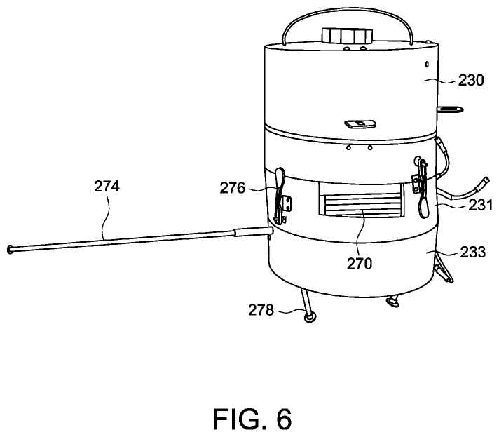

Another technical problem solved herein is a method for precise spraying. The technical solution provided herein is using a hovering UAV 200 and an extension rod 274 (shown in FIG. 6). The UAV 200 includes a reservoir 230 and an extension rod 274, which has a nozzle configured to spray liquid from the reservoir 230. The extension rod 274 is equipped with two or more servos that are attached to the extension rod 274 and can cause movement of the extension rod 274. A processor 210 (e.g., located in the electrical compartment 231) may output signals to the servos to cause movement of the extension rod 274. For example, the UAV 200 may be positioned at a predetermined point, and the servos may be activated to move or swing the extension rod 274 left or right, causing the nozzle to spray liquid along a predetermined line or within or around an assigned box.

In some embodiments, an effective spray width is about 1 meter to about 5 meters, with a spray flow of about 3 liters pers minute to about 5 liters per minute and a pump pressure of up to about 0.5 MPa.

The reservoir 230 contains the liquid to be sprayed. The reservoir 230 can retain various types of liquid, including oil-based liquid, water-based liquid, water, paint, crop protection chemicals, fire retardants, specialty liquids, and the like. The reservoir 230 can have a capacity of about 5 liters to about 20 liters and is reversibly couplable to the body 202. In some embodiments, the fuselage 204 (e.g., a reservoir 230 of the fuselage 204) includes a reliable communication system, such as one or more radios or Wi-Fi access points, to ensure that the body 202 of the UAV 200 can maintain a steady or reliable connection with the reservoir 230 or fuselage 204. In some embodiments, the reservoir 230 can include one or more sensors and monitoring equipment that can be used to provide real-time data on liquid levels, quality, and other parameters. These data can then be transmitted to the processor 210 of the UAV 200, allowing informed decisions.

The liquid application compartment 233 includes components for receiving liquid from the reservoir 230 and dispensing the liquid on a surface. The liquid application compartment 233 may further include an air pipe and an extension rod 274 (e.g., about 5 inches to about 20 inches or about 8 inches to about 15 inches) that improves control over the painting process. The liquid sprayer, for example in the liquid application compartment, may be a liquid sprayer (e.g., up to about 600 W liquid sprayer) that dispenses liquid through a mechanism that allows the user to control the amount of liquid applied and/or the width of the liquid stroke. In some embodiments, as shown in FIG. 6, the UAV 200 may optionally further include one or more servos that control a direction that an extension rod 274 is pointing, for example directionally left, right, up, and down.

In some embodiments, the processor 210 of the UAV 200 can coordinate the movement of an intelligent paint mixing system (IPMS). An IPMS may include one or more internal chambers in the reservoir 230, one or more pumps 280, and one or more valves. The IPMS can also include one or more sensors that provide real-time feedback on mixing factors, for example, paint levels and pressure. This feedback allows the processor 210 to adjust the operation of the IPMS to ensure consistent color and composition throughout the painting process. To achieve multi-color painting or mixed color painting, the UAV 200 can incorporate a multi-chambered reservoir 230 and a selection valve mechanism. The processor 210 can selectively activate the selection valve mechanism, allowing the UAV 200 to seamlessly switch between multiple colors during a painting task or cycle.

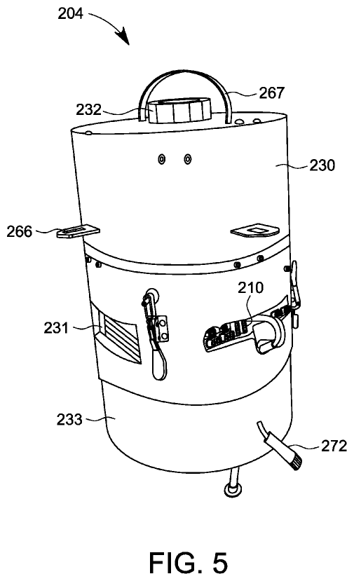

FIG. 5 shows a side view of an embodiment of a fuselage 204 of a UAV 200 for liquid application. As shown in FIG. 5, the fuselage 204, including the reservoir 230, includes a coupling element 266 (e.g., female snapping connector) that allows it to securely couple to the body 202 of the UAV 200 using, for example a complementary coupling element 252 (e.g., male snapping connector) on the body 202 of the UAV 200. Although a snap fit connection is shown, one of skill in the art will appreciate that any attachment means is contemplated herein. Further, although the reservoir 230 is shown having the female coupling elements 266 and the UAV 200 as having the male coupling element 252, one of skill in the art will appreciate that the reservoir 230 may have male coupling element and the UAV may have the female coupling element. The fuselage 204 may further include a handle 267. As described elsewhere herein, the fuselage 204 further includes an inlet 232 of the reservoir 230 and a processor 210. Also shown in FIG. 5 is a pump input 272. The pump input 272 electrically connects the pump 280 to the flight controller 224, so that the flight controller 224 can send commands to the pump 280.

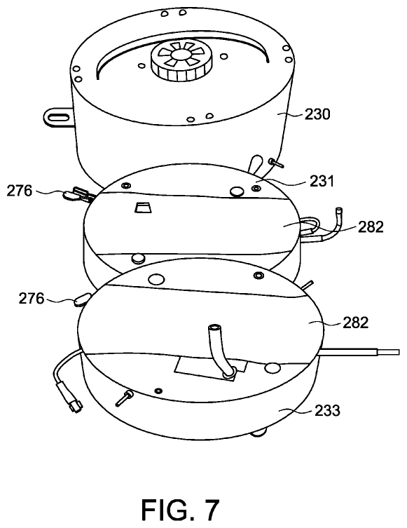

FIGS. 6-7 show various coupling elements for coupling together the various compartments of the fuselage 204. Although three compartments are shown (e.g., reservoir, electrical compartment, and liquid application compartment), one of skill in the art will appreciate that any number of compartments may be used. For example, components within disparate compartments may be combined into a compartment or components within the same compartment may be separated into separate compartments.

A first technical problem solved herein includes connecting the drone with a reservoir configured to contain a liquid (e.g., a paint, a pesticide, an herbicide, a sealant, water, a repellant, etc.) therein. Various methods could be employed to reversibly couple the UAV to the reservoir, like a magnetic coupling element or a mechanical coupling element. In some embodiments, a system for connecting a UAV and a reservoir may enable the UAV to carry the reservoir to a spraying location while ensuring a secure and stable connection between the UAV and the reservoir, as will be described in further detail elsewhere herein. When using UAVs for spraying purposes, the liquid can be transported in a reservoir that is mounted on the UAV. However, connecting the UAV to the reservoir can be challenging due to the different shapes and sizes of the two components. To overcome this technical problem, the UAV described herein may include an annular body or a body (e.g., circular, cuboidal, rectangular prism, etc.) defining an aperture that is sized and shaped to receive a complementary shaped fuselage therein. The body and fuselage may be coupled to one another using one or more coupling elements. For example, the body and fuselage may be coupled to one another using a mechanical connection (e.g., latch, clasp, connector, etc.). Alternatively, or additionally, the body and fuselage may be coupled to one another using a magnetic connection. The one or more coupling elements may prevent accidental disconnection during flight.

FIG. 6 shows a side view of an embodiment of a fuselage 204 of a UAV 200 for liquid application. The fuselage 204 includes a compartment coupling element 276 to couple the reservoir 230 to the electrical compartment 231 and to couple the electrical compartment 231 to the liquid application compartment 233. An extension rod 274 may extend from and be in fluid communication with the liquid application compartment 233. Also shown in FIG. 6 is the power source 270 in the electrical compartment 231 and one or more optional landing feet 278 (optionally including landing gears).

FIG. 7 shows a partially exploded view of an embodiment of a fuselage 204 of a UAV 200 for liquid application. In addition to the compartment coupling element 276 described above in FIG. 6 or alternatively to it, the fuselage 204 may include a magnetic coupling element 282 to couple the reservoir 230 to the electrical compartment 231 and to couple the electrical compartment 231 to the liquid application compartment 233. Compartment coupling element 276 and/or magnetic coupling element 282 function to secure the compartments of the fuselage 204 to one another, for example during transport by the UAV 200. The one or more magnetic coupling elements serve as a quick-connecting mechanism for the compartments of the fuselage 204, facilitating easy detachment of the compartments. The one or more magnetic coupling elements allow for swift and efficient maintenance or replacement of the reservoir 230, reducing downtime and increasing operational efficiency.

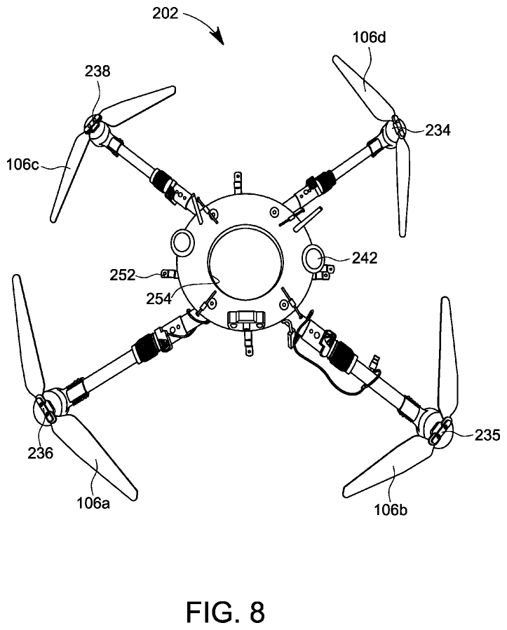

FIG. 8 shows a top view of an embodiment of a body 202 of a UAV 200 for liquid application. The body 202 may have an annular shape, toroidal shape, or other three-dimensional shape (e.g., square, rectangle, hexagon, octagon, etc.) defining an aperture therethrough. In some embodiments, body 202 is an annular body. Body 202 includes a plurality of motors 235, 234, 236, 238, each be coupled to a respective propeller 106a, 106b, 106c, 106d. Further, as shown in FIG. 8, the body 202 includes a GPS receiver 242 (capable of RTK in some embodiments), one or more coupling element(s) 252 to couple the body 202 to the fuselage 204, and one or more electronic connections 254 to the fuselage 204. The one or more electronic connections 254 connect to the pump input 272 for the pump 280.

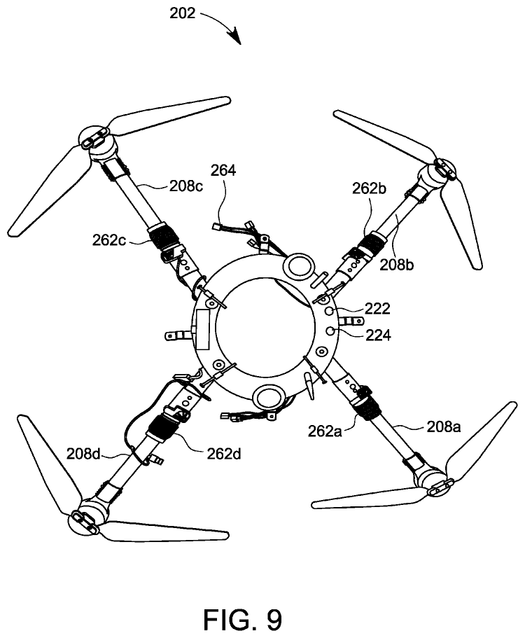

FIG. 9 shows a top view of an embodiment of a body 202 of a UAV 200 for liquid application. The body 202 of the UAV 200 includes a receiver 222 (as described elsewhere herein), flight controller 224 (as described elsewhere herein), and electrical connection 264 to fuselage 204. Electrical connection 264 can connect the power source 270 to the body 202.

Electrical connection 264 can connect the power source 270 to the processor 210. Body 202 includes a plurality of arms, for example arm 208a, arm 208b, arm 208c, arm 208d. Each arm may be hingeable or foldable relative to the body 202, for example along respective foldable sections 262a, 262b, 262c, 262d.

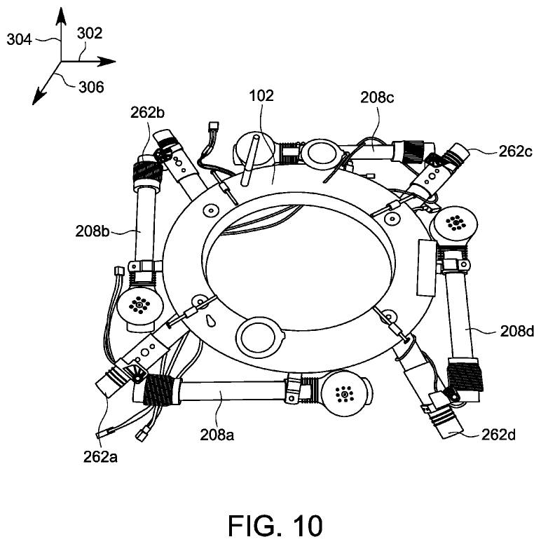

FIG. 10 shows a top view of an embodiment of a body 202 of a UAV 200 for liquid application in an inactive or folded or storage configuration. As shown in FIG. 10, the plurality of arms 208a, 208b, 208c, 208d each fold relative to the body 202 along foldable section 262a, 262b, 262c, 262d. The plurality of arms may fold relative to the body 202 within a transverse plane (formed by reference to the x-axis 302 and the z-axis 304) of the body 202. The folded configuration of the UAV 200, shown in FIG. 10, is an inactive configuration (i.e., non-flying configuration).

In some embodiments, any of the UAV embodiments described herein can be equipped with a pre-painting system, for example, a blaster. The pre-painting system may be detachable from the UAV or integrated into the UAV. The processor can output an activation signal to the pre-painting system and cause the pre-painting system to execute one or more options. The pre-painting system may enable the UAV to perform automated surface cleaning and/or priming before painting.

In some embodiments, any of the UAV embodiments described herein can integrate with one or more collaborative robotics through a designated landing pad or docking station. The flight controller (with optionally integrated or separate GPS, receiver, ESC, etc.) can facilitate communication and docking with ground-based robots for paint reservoir switching during operation.

In some embodiments, any of the UAV embodiments described herein may include a “one button” take-off and landing function so that the UAV can take off and land automatically with the input from a single button, making it easy for beginners or inexperienced pilots to operate the UAV.

In some embodiments, any of the UAV embodiments described herein may include various features that increase safety and save time, including one-button take-off and landing, continuing spraying at breakpoints, and automatic return when the liquid is finished, or the battery is low. Any of the UAV embodiments described herein may also include liquid amount detection, battery detection, height control radar, obstacle avoidance function, and the like. Any of the UAV embodiments described herein may also optionally have a dual pump mode, camera for capturing images or video with optional real-time transmission, and/or external RTK positioning.

The optional features of one button take-off and landing, continue spraying at breakpoint, auto return, liquid detection, break point record setting, battery detection, low battery return and record point setting, height control radar, stable altitude setting, supporting imitative Earth function, flying layout setting, vibration protection, and lost connection protection to increase safety, save time, and provide stability when using the equipment.

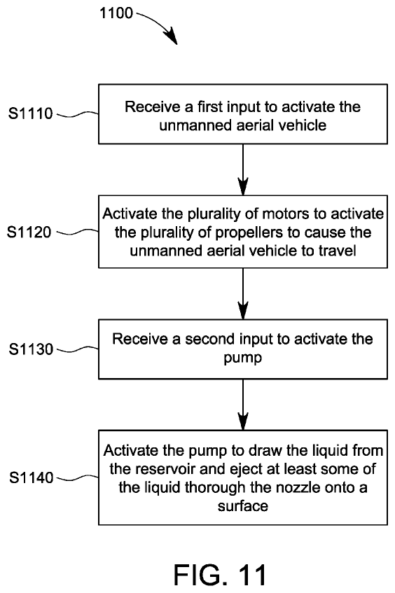

As shown in FIG. 11, a method 1100 for operating a UAV 200 for liquid application of an embodiment includes receiving a first input to activate the unmanned aerial vehicle at block S1110; activating the plurality of motors to activate the plurality of propellers to cause the unmanned aerial vehicle to travel at block S1120; receiving a second input to activate a pump at block S1430; and activating the pump to draw liquid from the reservoir and eject the liquid through the nozzle onto a surface at block S1440. The method functions to navigate a UAV for liquid application to a target site, autonomously or using an input device (or computing device). In some embodiments, the method 1100 functions to operate a UAV for applying a liquid to a surface. The method is used for the infrastructure maintenance and repair fields, but can additionally, or alternatively, be used for any suitable applications, industrial or otherwise.

As shown in FIG. 11, an embodiment of a method 1100 for operating a UAV includes block S1110, which recites receiving a first input to activate the unmanned aerial vehicle. In some embodiments, receiving includes receiving a target location for painting, for example receiving a signal from a GPS receiver, from an input (e.g., user input from a computing device), a LiDAR map, a 3D map, or otherwise receiving a target location. The target location may be the site of an infrastructure for repair or painting.

As shown in FIG. 11, an embodiment of a method 1100 for operating a UAV includes block S1120, which recites activating the plurality of motors to activate the plurality of propellers to cause the unmanned aerial vehicle to travel. In some embodiments, travel may be to a target location.

As shown in FIG. 11, an embodiment of a method 1100 for operating a UAV includes block S1130, which recites receiving a second input to activate a pump. In some embodiments, receiving includes receiving a signal from an input device (e.g., user input from a computing device). In some embodiments, receiving includes receiving an automatic indication to activate the pump based on arrival at a target location. The target location may be the site of an infrastructure for repair or painting.

As shown in FIG. 11, an embodiment of a method 1100 for operating a UAV includes block S1140, which recites activating the pump to draw liquid from the reservoir and eject the liquid through the nozzle onto a surface. The pump activation may occur upon arriving at the target location. Pump activation may include activating the applicator to dispense at least some of the liquid from the reservoir onto a surface for painting.

The method may optionally further include activating one or more servos to control a direction of extension rod to alter a painting direction of the applicator.

In some embodiments, the method 1100 may optionally include receiving an indication of liquid in the reservoir. An amount, volume, or level of liquid may be measured by one or more sensors of the UAV and/or based on input (e.g., input at a computing device).

### EXAMPLES

Example 1. An unmanned aerial vehicle comprising: an annular body comprising a plurality of motors; a plurality of propellers coupled to the annular body and electrically coupled to the plurality of motors; and a fuselage removably insertable into the annular body and electrically connectable to the annular body, wherein the fuselage comprises: a processor coupled to a memory, a reservoir configured to contain a liquid therein, a pump fluidly connected to the reservoir, a nozzle fluidly connected to the reservoir and the pump, and a power source electrically coupled to the plurality of motors and the plurality of propellers when the fuselage is coupled to the annular body, the processor, the memory, and the pump.

Example 2. The unmanned aerial vehicle of any one of the preceding examples, but particularly Example 1, wherein the annular body further comprises a flight controller, a location sensor, and a receiver, each being electrically coupled to the power source and the processor.

Example 3. The unmanned aerial vehicle of any one of the preceding examples, but particularly Example 1, wherein each propeller of the plurality of propellers is coupled to the annular body via a respective arm.

Example 4. The unmanned aerial vehicle of any one of the preceding examples, but particularly Example 3, wherein each arm is foldable relative to the annular body to configure the unmanned aerial vehicle into an inactive configuration.

Example 5. The unmanned aerial vehicle of any one of the preceding examples, but particularly Example 1, wherein the fuselage comprises a plurality of separable compartments.

Example 6. The unmanned aerial vehicle of any one of the preceding examples, but particularly Example 5, wherein a first compartment defines the reservoir; a second compartment comprises the processor, the memory, and the power source; and a third compartment comprises the pump and the nozzle.

Example 7. The unmanned aerial vehicle of any one of the preceding examples, but particularly Example 5, wherein the plurality of separable compartments is mechanically coupled to each other.

Example 8. The unmanned aerial vehicle of any one of the preceding examples, but particularly Example 5, wherein the plurality of separable compartments is magnetically coupled to each other.

Example 9. The unmanned aerial vehicle of any one of the preceding examples, but particularly Example 5, wherein the plurality of separable compartments is mechanically and magnetically coupled to each other.

Example 10. The unmanned aerial vehicle of any one of the preceding examples, but particularly Example 1, wherein the reservoir further comprises a liquid sensor configured to sense an amount of the liquid in the reservoir, the liquid sensor being electrically coupled to the power source and the processor.

Example 11. The unmanned aerial vehicle of any one of the preceding examples, but particularly Example 1, wherein the unmanned aerial vehicle further comprises a weight sensor configured to sense an amount of the liquid in the reservoir, the weight sensor being electrically coupled to the power source and the processor.

Example 12. The unmanned aerial vehicle of any one of the preceding examples, but particularly Example 2, wherein the processor is configured to execute instructions comprising: receiving a first input to activate the unmanned aerial vehicle; activating the plurality of motors to activate the plurality of propellers to cause the unmanned aerial vehicle to travel; receiving a second input to activate the pump; and activating the pump to draw the liquid from the reservoir and eject at least some of the liquid through the nozzle onto a surface.

Example 13. The unmanned aerial vehicle of any one of the preceding examples, but particularly Example 12, further comprising a user input device configured to transmit one or both of: the first input or the second input to the unmanned aerial vehicle.

Example 14. The unmanned aerial vehicle of any one of the preceding examples, but particularly Example 1, wherein the liquid is paint.

Example 15. The unmanned aerial vehicle of any one of the preceding examples, but particularly Example 12, wherein the surface comprises a portion of an infrastructure.

Example 16. The unmanned aerial vehicle of any one of the preceding examples, but particularly Example 12, wherein the nozzle further comprises an extension rod.

Example 17. The unmanned aerial vehicle of any one of the preceding examples, but particularly Example 16, wherein the processor is configured to adjust a position of the extension rod to positionally adjust the ejecting of the at least some of the liquid.

Example 18. The unmanned aerial vehicle of any one of the preceding examples, but particularly Example 1, wherein the annular body further comprises a mini battery system, separate from the power source, wherein the mini battery system comprises: a power supplier configured to switch from the power source to the mini battery system upon disconnection of the power source; and a timer configured to maintain power to the annular body for a predetermined period after the power source is disconnected.

Example 19. The unmanned aerial vehicle of any one of the preceding examples, but particularly Example 18, wherein the mini battery system is a rechargeable battery.

Example 20. The unmanned aerial vehicle of any one of the preceding examples, but particularly Example 18, wherein the predetermined period is up to about 20 seconds.

Example 21. The unmanned aerial vehicle of Example 18, wherein the power supplier is a switch.

Example 22. The unmanned aerial vehicle of any one of the preceding examples, but particularly Example 18, wherein the power supplier is a relay.

Example 23. The unmanned aerial vehicle of any one of the preceding examples, but particularly Example 18, wherein the timer is programmable.

Example 24. The unmanned aerial vehicle of any one of the preceding examples, but particularly Example 18, wherein the timer is a microcontroller.

Example 25. The unmanned aerial vehicle of any one of the preceding examples, but particularly Example 18, further comprising a sensor for detecting the disconnection of the power source.

Example 26. The unmanned aerial vehicle of any one of the preceding examples, but particularly Example 25, wherein the sensor is a switch.

Example 27. The unmanned aerial vehicle of any one of the preceding examples, but particularly Example 25, wherein the sensor is a Hall effect sensor.

Example 28. A method for maintaining power to an unmanned aerial vehicle during replacement or transfer of a reservoir, comprising: a mini battery system attached to a body of the unmanned aerial vehicle, separate from a main power source; a power supplier configured to switch from the main power source to the mini battery system upon disconnection of the main power source; and a timer configured to maintain the power to the unmanned aerial vehicle for a predetermined period after the main power source is disconnected.

Example 29. A battery system for an unmanned aerial vehicle (UAV) and a reservoir system, comprising: a battery housing configured to receive and hold a power source; and a power output module integrated with the battery housing, the power output module comprising: a plurality of output connectors, each connector configured to transfer an amount of electrical power; a power management unit configured to manage a distribution of the electrical power from the power source to the plurality of output connectors; and a control circuit is configured to regulate a flow of power to the plurality of output connectors based on one or more power requirements of the UAV and the reservoir system.

Example 30. The battery system of any one of the preceding examples, but particularly Example 29, further comprising a connector module integrated with the battery housing and connected to the power output module, the connector module comprising: a first connector configured to receive the electrical power from the power source; second connector configured to provide the electrical power to the UAV; a third connector configured to provide the electrical power to the reservoir system; and one or more additional connectors configured to provide the electrical power to other equipment.

Example 31. The battery system of any one of the preceding examples, but particularly Example 30, further comprising a plurality of pins, each pin configured to connect the battery system to a corresponding port on the UAV and the reservoir system.

Example 32. The battery system of any one of the preceding examples, but particularly Example 30, wherein the power output module further comprises a voltage regulator, the voltage regulator configured to substantially maintain a constant voltage output to the plurality of output connectors.

Example 33. The battery system of any one of the preceding examples, but particularly Example 30, wherein the control circuit is configured to monitor a transfer of the power between the battery system, the reservoir system, and the UAV, and to adjust a power output of the battery system to ensure that each system receives the amount of the power.

Example 34. The battery system of any one of the preceding examples, but particularly Example 30, further comprising a safety circuit configured to detect and prevent overloading or short-circuiting of electrical circuits, and to shut down battery systems if an overload or short-circuit is detected.

Example 35. A system for spraying a liquid comprising: a spraying unmanned aerial vehicle comprising a reservoir and an extension rod, the extension rod having a nozzle configured to spray the liquid from the reservoir; two or more servos attached to the extension rod, the two or more servos being configured to move the extension rod; and a control system configured to control the two or more servos and a movement of the reservoir, wherein the spraying unmanned aerial vehicle is positioned at a predetermined point, and the two or more servos are activated to rotate the extension rod, causing the nozzle to spray a predetermined line or an assigned box.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on the drone and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “propeller” may include, and is contemplated to include, a plurality of propellers. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An unmanned aerial vehicle comprising:
an annular body comprising a plurality of motors;
a plurality of propellers coupled to the annular body and electrically coupled to the plurality of motors; and
a fuselage removably insertable into the annular body and electrically connectable to the annular body, wherein the fuselage comprises:
a processor coupled to a memory,
a reservoir configured to contain a liquid therein,
a pump fluidly connected to the reservoir,
a nozzle fluidly connected to the reservoir and the pump, and
a power source electrically coupled to the plurality of motors and the plurality of propellers when the fuselage is coupled to the annular body, the processor, the memory, and the pump.
wherein the annular body further comprises a mini battery system, separate from the power source, wherein the mini battery system comprises:
a power supplier configured to switch from the power source to the mini battery system upon disconnection of the power source; and
a timer configured to maintain power to the annular body for a predetermined period after the power source is disconnected.

2. The unmanned aerial vehicle of claim 1, wherein the annular body further comprises a flight controller, a location sensor, and a receiver, each being electrically coupled to the power source and the processor.

3. The unmanned aerial vehicle of claim 1, wherein each propeller of the plurality of propellers is coupled to the annular body via a respective arm.

4. The unmanned aerial vehicle of claim 3, wherein each arm is foldable relative to the annular body to configure the unmanned aerial vehicle into an inactive configuration.

5. The unmanned aerial vehicle of claim 1, wherein the fuselage comprises a plurality of separable compartments.

6. The unmanned aerial vehicle of claim 5, wherein a first compartment defines the reservoir; a second compartment comprises the processor, the memory, and the power source; and a third compartment comprises the pump and the nozzle.

7. (canceled)

8. (canceled)

9. The unmanned aerial vehicle of claim 5, wherein the plurality of separable compartments is mechanically or magnetically coupled to each other.

10. The unmanned aerial vehicle of claim 1, wherein the reservoir further comprises a liquid sensor configured to sense an amount of the liquid in the reservoir, the liquid sensor being electrically coupled to the power source and the processor.

11. The unmanned aerial vehicle of claim 1, wherein the unmanned aerial vehicle further comprises a weight sensor configured to sense an amount of the liquid in the reservoir, the weight sensor being electrically coupled to the power source and the processor.

12. The unmanned aerial vehicle of claim 2, wherein the processor is configured to execute instructions comprising:
receiving a first input to activate the unmanned aerial vehicle;
activating the plurality of motors to activate the plurality of propellers to cause the unmanned aerial vehicle to travel;
receiving a second input to activate the pump; and
activating the pump to draw the liquid from the reservoir and eject at least some of the liquid through the nozzle onto a surface.

13. The unmanned aerial vehicle of claim 12, further comprising a user input device configured to transmit one or both of: the first input or the second input to the unmanned aerial vehicle.

14. The unmanned aerial vehicle of claim 1, wherein the liquid is paint.

15. The unmanned aerial vehicle of claim 12, wherein the surface comprises a portion of an infrastructure.

16. The unmanned aerial vehicle of claim 12, wherein the nozzle further comprises an extension rod.

17. The unmanned aerial vehicle of claim 16, wherein the processor is configured to adjust a position of the extension rod to positionally adjust the ejecting of the at least some of the liquid.

18. (canceled)

19. (canceled)

20. The unmanned aerial vehicle of claim 1, wherein the predetermined period is up to about 20 seconds.

21. The unmanned aerial vehicle of claim 1, wherein the power supplier is a switch or a relay.

22. (canceled)

23. (canceled)

24. The unmanned aerial vehicle of claim 1, wherein the timer is a microcontroller.

25. The unmanned aerial vehicle of claim 1, further comprising a sensor for detecting the disconnection of the power source.

26. The unmanned aerial vehicle of claim 25, wherein the sensor is a switch or a Hall effect sensor.

27. (canceled)

28.-35. (canceled)
